(19) United States
(12) Patent Application Publication
(10) Pub. No.: US 2014/0145984 A1
(43) Pub. Date: May 29, 2014

(54) INPUT DEVICE, DISPLAY APPARATUS, DISPLAY SYSTEM AND METHOD OF CONTROLLING THE SAME

(71) Applicant: SAMSUNG ELECTRONICS CO., LTD., Suwon-si (KR)

(72) Inventors: Yeo-ri YOON, Cheongju-si (KR); Chang-soo LEE, Seoul (KR); Sang-hee LEE, Seoul (KR)

(73) Assignee: SAMSUNG ELECTRONICS CO., LTD., Suwon-si (KR)

(21) Appl. No.: 14/079,795

(22) Filed: Nov. 14, 2013

(30) Foreign Application Priority Data
Nov. 23, 2012 (KR) 10-2012-0133534

(51) Int. Cl. G06F 3/041

(52) U.S. Cl. CPC G06F 3/0416
USPC 345/173

(57) ABSTRACT

An input device, a display apparatus, a display system and a control method are provided. The input device for the display apparatus includes a communication device which communicates with the display apparatus; a touch sensor which comprises predetermined regions corresponding to a plurality of edges a screen of the display apparatus has, and receives a user's touch input; and a controller which determines a direction of a touch with respect to the predetermined region. Thus, a user can perform a certain input without looking the touch sensor and an intuitive input without separate learning.

### CROSS-REFERENCE TO RELATED APPLICATION

This application claims priority from Korean Patent Application No. 10-2012-0133534, filed on Nov. 23, 2012 in the Korean Intellectual Property Office, the disclosure of which is incorporated herein by reference.

### BACKGROUND

1. Field

Apparatuses and methods consistent with the exemplary embodiments relate to an input device, a display apparatus, a display system and a method of controlling the same, and more particularly to an input device including a touch sensor to receive a user's touch input, a display apparatus, a display system and a method of controlling the same.

2. Description of the Related Art

Until recently, a touch sensor of a touch remote controller used together with a display apparatus has a structure where a user has to look directly at the touch sensor and press a designated area of the touch sensor in order to perform an operation separately defined on a touch pad, for example, to perform a channel change operation or a volume control operation or the like.

Also, the touch sensor has an entirely flat surface, so that the same touch operation can be performed wherever a user touches.

Further, a separate learning process is needed for a user to carry out certain control operations.

### SUMMARY

An exemplary embodiment may provide an input device, a display apparatus, a display system and a method of controlling the same, in which a user does not have to look at a touch sensor in order to carry out a certain input.

An aspect of an exemplary embodiment may provide an input device, a display apparatus, a display system and a method of controlling the same, in which a user can carry out an intuitive input without a separate learning process.

According to another aspect of an exemplary embodiment, an input device for a display apparatus includes: a communication device configured to communicate with the display apparatus; a touch sensor configured to include predetermined regions corresponding to a plurality of edges of a screen of the display apparatus, and receive a user's touch input; and a controller configured to determine a direction of a touch with respect to the predetermined region.

The direction of the touch input may include a direction traversing the predetermined region and a direction following the predetermined region.

The display apparatus may activate a menu from one edge of the screen corresponding to the determined direction of the touch input among the plural edges of the screen while communicating with the communication device.

The predetermined region may be shaped like a bar having a predetermined length.

The predetermined region may be shaped like a dot.

The predetermined region may protrude to a predetermined height.

The predetermined region may be grooved to have a predetermined depth.

According to an aspect of an exemplary embodiment, a display apparatus includes: a signal receiver configured to receive a video signal; a signal processor configured to process the video signal; a display configured to display an image based on the video signal on a screen; a communication device configured to communicate with an input device which receives a user's touch input; and a controller configured to control a menu to be activated from one edge of the screen corresponding to the touch input among the plural edges of the screen.

The input device may include a predetermined region protruding in relation to the plurality of edges, and a direction of the touch input is determined with respect to the predetermined region.

The direction of the touch input may include a direction traversing the predetermined region and a direction following the predetermined region.

The predetermined region may be shaped like a bar having a predetermined length.

The predetermined region may be shaped like a dot.

The predetermined region may protrude to a predetermined height.

The predetermined region may be grooved to have a predetermined depth.

According to an aspect of an exemplary embodiment, a display system includes a display apparatus and an input device, the display apparatus including: a signal receiver configured to receive a video signal; a signal processor configured to process the video signal; a display configured to display an image based on the video signal on a screen; a communication device configured to communicate with an input device which receives a user's touch input; and a controller configured to control a menu to be activated from one edge of the screen corresponding to the touch input among plural edges of the screen, and the input device including: a communication device configured to communicate with the display apparatus; a touch sensor configured to include predetermined regions corresponding to a plurality of edges of a screen of the display apparatus, and receive a user's touch input; and a controller configured to determine a direction of a touch with respect to the predetermined region.

The direction of the touch input may include a direction traversing the predetermined region and a direction following the predetermined region.

The display apparatus may activate a menu from one edge of the screen corresponding to the determined direction of the touch input among the plural edges of the screen while communicating with the communication device.

The predetermined region may be shaped like a bar having a predetermined length.

The predetermined region may be shaped like a dot.

The predetermined region may protrude to a predetermined height.

The predetermined region may be grooved to have a predetermined depth.

According to an aspect of an exemplary embodiment, a control method of a display system including a display apparatus and an input device includes: inputting, by a user, a touch through the input device, the input device including a predetermined region protruding in relation to a plurality of edges of a screen of the display apparatus; determining, by the input device, a direction of a user's touch input with respect to the predetermined region; transmitting, by the input device, a user's touch input, of which the direction is determined, to the display apparatus; and controlling, by the display apparatus, a menu to be activated from one edge of the screen corresponding to the received user's touch input among the plurality of edges of the screen.

The determining, by the input device, of the direction of the user's touch input with respect to the predetermined region may include determining one of a direction traversing the predetermined region and a direction following the predetermined region.

If it is determined that the user's touch input traverses the predetermined region, the display apparatus may control a menu to be activated from one edge of the screen corresponding to the received user's touch input among the plurality of edges of the screen.

If it is determined that the user's touch input follows the predetermined region, the display apparatus may control a scroll operation to be inputted with regard to an item of the activated menu.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a block diagram of a display system according to an exemplary embodiment;

FIG. 2 is a schematic plan view of a touch sensor included in an input device for the display apparatus according to an exemplary embodiment;

FIG. 3 is a schematic section view of the touch sensor of FIG. 2 from a bottom view;

FIG. 4 is a schematic section view of a touch sensor included in an input device for a display apparatus from a bottom view, according to another exemplary embodiment;

FIG. 5 is a schematic plan view of a touch sensor included in an input device for a display apparatus from a top view, according to still another exemplary embodiment;

FIG. 6 is a schematic plan view of a touch sensor included in an input device for a display apparatus from a top view, according to yet another exemplary embodiment;

FIG. 7 is a schematic view showing an on screen display (OSD) displayed sliding from an edge of the screen, on the screen of the display apparatus according to an exemplary embodiment;

FIG. 8 is a schematic view showing a scroll operation in a menu item displayed sliding from the edge of the screen in accordance with a touch input, on the screen of the display apparatus according to an exemplary embodiment the display apparatus;

FIG. 9 is a flowchart illustrating a control method of the display system according to an exemplary embodiment; and

FIG. 10 is a flowchart illustrating a control method of the display system according to another exemplary embodiment.

### DETAILED DESCRIPTION OF EXEMPLARY EMBODIMENTS

Below, exemplary embodiments will be described in detail with reference to accompanying drawings.

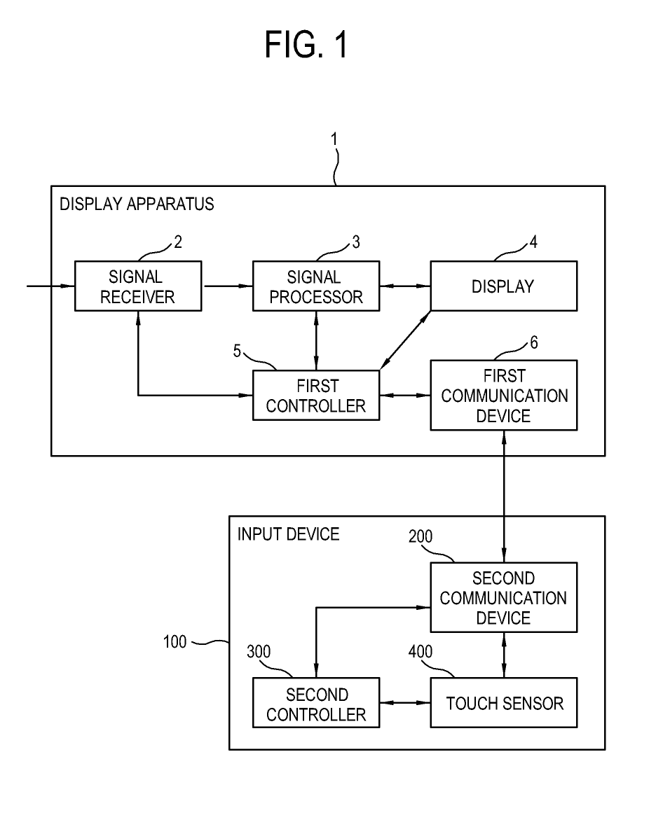

FIG. 1 is a block diagram of a display system according to an exemplary embodiment;

As shown in FIG. 1, the display system according to an exemplary embodiment includes a display apparatus 1 and an input device 100.

The display apparatus 1 may include various apparatuses which display an image. In this exemplary embodiment, a television (TV) will be described as an example of the display apparatus 1. However, this is only exemplary, since the display apparatus is not limited to a television.

The display apparatus 1 includes a signal receiver 2 which receives a video signal; a signal processor 3 which processes a video signal; a display 4 which displays an image based on a video signal; a first communication device 6 which communicates with an input device 100 receiving a user's touch input; and a first controller 5 which activates a menu from one edge of the screen corresponding to the touch input among a plurality of edges in response to the touch input.

The signal receiver 2 of the display apparatus 1 may receive a video signal from an external source through a connector (not shown) or may receive a video signal from an interior storage (not shown). The signal receiver 2 sends the received video signal to the signal processor 3.

The signal processor 3 of the display apparatus 1 processes the video signal received by the signal receiver 2 to be displayable on the display 4, and sends the processed video signal to the display 4.

The display 4 of the display apparatus 1 displays an image based on the video signal processed by the signal processor 3.

The communication device 6 of the display apparatus 1 communicates with the input device 100 which receives a user's touch input, and receives a command corresponding to the user's touch input, thereby transmitting the command to the first controller 5.

The controller 5 of the display apparatus 1 activates a menu from one edge of the screen corresponding to the touch input among a plurality of edges of the screen in response to the touch input from the input device 100. In general, the screen of the display apparatus 1 has all four edges, i.e., top, bottom, left and right edges. Also, the menu activated corresponding to the touch input may include an on screen display (OSD) or a similar menu.

The input device 100 of the display apparatus 1 includes a touch remote controller for remotely controlling the display apparatus 1, but is not limited thereto. Alternatively, the input device 100 may include any device which has a touch function and transmits an input to the display apparatus 1.

The input device 100 includes a second communication device 200 which communicates with the display apparatus 1; a touch sensor 400 which includes predetermined regions 401, 402, 403, 404, 402′, 403′, 404′, 405, 406, 407, 408, an 409 corresponding to the plural edges of the screen of the display apparatus 1, and receives a user's touch input; and a controller 300 which determines a direction of a touch input with respect to the predetermined regions 401, 402, 403, 404, 402′, 403′, 404′, 405, 406, 407, 408, and 409.

The second communication device 200 of the input device 100 may transmit a command corresponding to a user's touch input to the first communication device 6 of the display apparatus 1.

The touch sensor 400 of the input device 100 includes the predetermined regions 401, 402, 403, 404, 402′, 403′, 404′, 405, 406, 407, 408, and 409 corresponding to the plurality of edges that the screen of the display apparatus 1. Therefore, the number of predetermined regions provided in the touch sensor 400 corresponds to the number of edges that the screen of the display apparatus 1 has. The predetermined regions 401, 402, 403, 404, 402′, 403′, 404′, 405, 406, 407, 408, and 409 of the touch sensor 400 are provided to receive a user's touch input. Here, a user's touch input on the predetermined regions 401, 402, 403, 404, 402′, 403′, 404′, 405, 406, 407, 408, and 409 may be achieved by various touch input methods. For example, the touch input methods may include a resistive method, a capacitive method, a piezo-resistive method, etc.

The predetermined regions 401, 402, 403, 404, 402′, 403′, 404′, 405, 406, 407, 408, and 409 may be distinguished from the other regions of the touch sensor 400 by various shapes, texture, etc.

Specifically, the predetermined regions 401, 402, 403, 404, 402′, 403′, 404′, 405, 406, 407, 408, and 409 may have various shapes as follows.

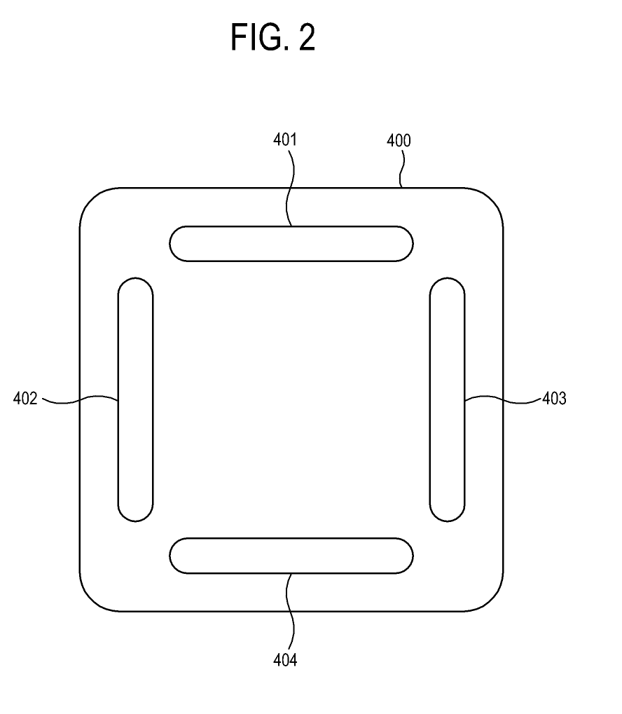

FIG. 2 is a schematic plan view of the touch sensor 400 included in the input device 100 for the display apparatus 1 according to an exemplary embodiment.

As shown in FIG. 2, the touch sensor 400 of the input device 100 includes four predetermined regions 401, 402, 403, and 404 corresponding to four edges that the screen of the display apparatus 1 has. In this exemplary embodiment, the predetermined regions 401, 402, 403, and 404 protrude from the plane of the touch sensor 400, and may be shaped like a predetermined bar.

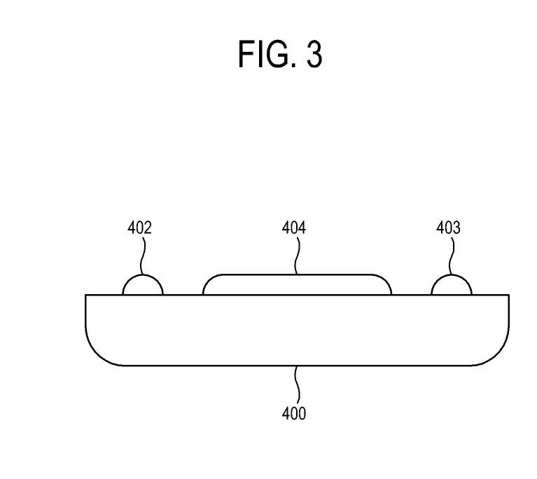

FIG. 3 is a schematic section view of the touch sensor 400 of FIG. 2 from a bottom view.

As shown in FIG. 3, such predetermined regions 401 (not shown), 402, 403, and 404 which may be shaped like a bar, protrude to have a height and a width so as to be sensed by a user's finger, and may have a predetermined length.

On the other hand, the predetermined regions 401, 402, 403, and 404 may be grooved to have a predetermined depth, which is different from a protrusion from the plane of the touch sensor 400.

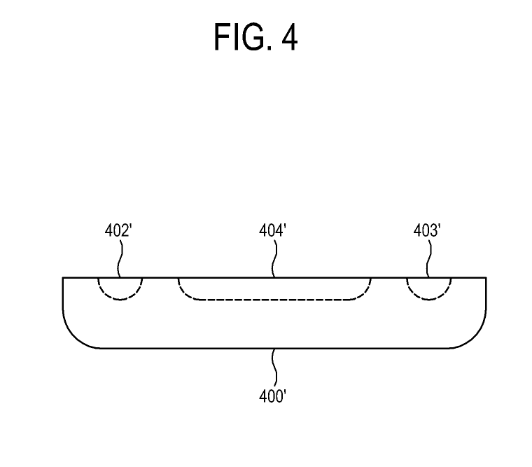

FIG. 4 is a schematic section view of a touch sensor 400 included in an input device 100 for a display apparatus 1 from a bottom view, according to another exemplary embodiment;

As shown in FIG. 4, predetermined regions 402′, 403′, and 404′ provided corresponding to four edges that the screen of the display apparatus 1 has are recessed to have a depth and a width so as to be sensed by a user's finger, and may have a predetermined length.

The predetermined regions 401, 402, 403, 404 may not be individually provided corresponding to four edges that the screen of the display apparatus 1 has, but may be formed as a single body having a shape corresponding to the screen.

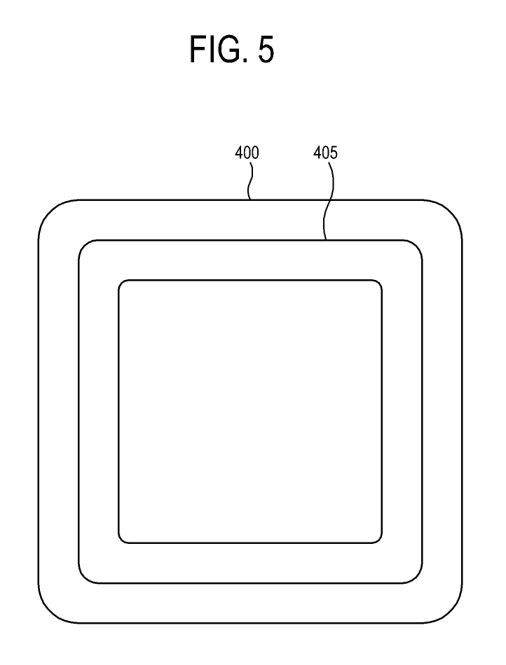

FIG. 5 is a schematic plan view of a touch sensor included in an input device for a display apparatus from a top view, according to still another exemplary embodiment.

In this exemplary embodiment, a rectangular closed curve having a predetermined width and having a rounded corner is illustrated as a predetermined region 405, but is not limited thereto. Alternatively, the predetermined region 405 may have various shapes. For example, the predetermined region 405 may be a circular closed curve.

The predetermined regions 402′, 403′, and 404′ provided corresponding to four edges that the screen of the display apparatus 1 has may be provided in the form of dots that can be sensed by a user's finger.

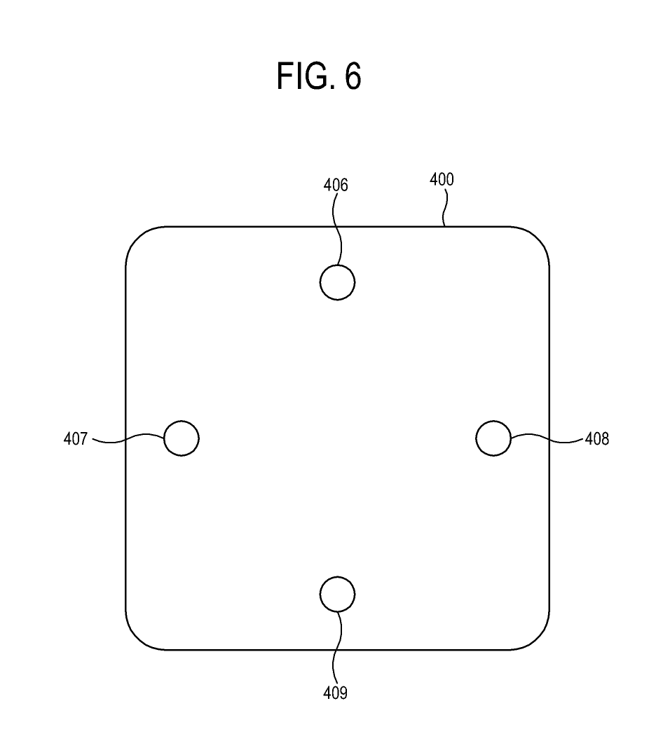

FIG. 6 is a schematic plan view of a touch sensor 400 included in an input device 100 for a display apparatus 1 from a top angle, according to yet another exemplary embodiment. In this embodiment, each dot for the predetermined regions 406, 407, 408, and 409 are shaped like a circle, but is not limited thereto. Alternatively, instead of a dot, the predetermined regions 406, 407, 408, and 409 may have various shapes. For example, the predetermined regions 406, 407, 408, and 409 may be shaped like a diamond.

The foregoing various shapes for the predetermined regions 401, 402, 403, 404, 402′, 403′, 404′, 405, 406, 407, 408, and 409 may be combined. For example, left and right regions may be achieved by grooves, and top and bottom regions may be achieved by protrusions. For example, only the top and bottom regions may be achieved by protrusions, and left and right regions may be provided on the same plane as the touch sensor 400 without any specific shape.

The predetermined regions of the touch sensor 400 in the input device 100 may have different textures. For example, the entire regions of the touch sensor 400 may be even or smooth. However, only the portion corresponding to the predetermined region may be coarse.

Alternatively, the predetermined region of the touch sensor 400 may be provided as only a designated area without having any separate shape.

Referring back to FIG. 1, the second controller 300 of the input device 100 may determine the directions of the touch input with respect to the predetermined regions 401, 402, 403, 404, 402′, 403′, 404′, 405, 406, 407, 408 and 409.

In other words, a direction of a user's touch input may include a direction traversing the predetermined regions 401, 402, 403, 404, 402′, 403′, 404′, 405, 406, 407, 408, and 409 and a direction moving along the predetermined regions 401, 402, 403, 404, 402′, 403′, 404′, 405, 406, 407, 408, and 409.

If it is determined that the direction of the user's touch input traverses the predetermined regions 401, 402, 403, 404, 402′, 403′, 404′, 405, 406, 407, 408, and 409, the second controller 300 of the input device 100 for the display apparatus 1 may issue a command for activating a menu from one edge of the screen corresponding to the user's touch input among the plurality of edges on the screen, and transmit the command to the first communication device 6 of the display apparatus 1.

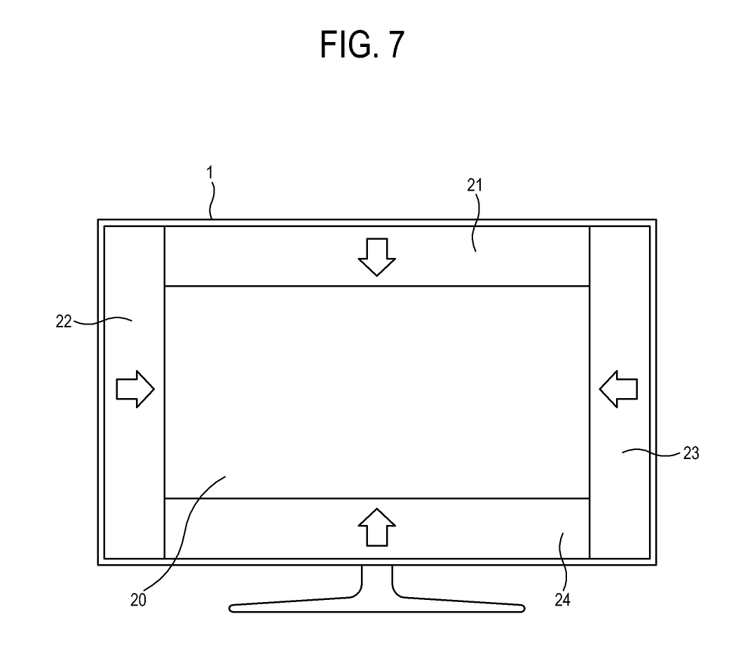

FIG. 7 is a schematic view showing an on screen display (OSD) displayed sliding from an edge of the screen, on the screen of the display apparatus 1 according to an exemplary embodiment.

For example, if a user touches the predetermined region 401 of the touch sensor 400 of the input device 100 in a traverse direction from a top to a bottom, the display apparatus 1 displays an OSD 21 sliding from a top edge of the screen in response to the traverse touching operation. If a user touches the predetermined region 402 of the touch sensor 400 of the input device 100 in a traverse direction from left to right, the display apparatus 1 displays an OSD 22 sliding from a left edge of the screen in response to the traverse touching operation. If a user touches the predetermined regions 403 of the touch sensor 400 of the input device 100 in a traverse direction from right to left, the display apparatus 1 displays an OSD 23 sliding from a right edge of the screen in response to the traverse touching operation. If a user touches the predetermined region 404 of the touch sensor 400 of the input device 100 in a traverse direction from a bottom to a top, the display apparatus 1 displays an OSD 24 sliding from a bottom edge of the screen in response to the traverse touching operation.

Then, if a user touches the predetermined region 401 of the touch sensor 400 of the input device 100 in a traverse direction from a bottom to a top, the display apparatus 1 makes an OSD 24 displayed from the top edge of the screen disappear sliding in response to the traverse touching operation. If a user touches the predetermined region 402 of the touch sensor 400 of the input device 100 in a traverse direction from a right to a left, the display apparatus 1 makes an OSD 22 displayed from the left edge of the screen disappear sliding in response to the traverse touching operation. If a user touches the predetermined region 403 of the touch sensor 400 of the input device 100 in a traverse direction from a left to a right, the display apparatus 1 makes an OSD 23 displayed from the right edge of the screen disappear sliding in response to the traverse touching operation. If a user touches the predetermined region 404 of the touch sensor 400 of the input device 100 in a traverse direction from a top to a bottom, the display apparatus 1 makes an OSD 24 displayed from the bottom edge of the screen disappear sliding in response to the traverse touching operation.

Besides the foregoing method of making the OSD disappear sliding in response to the reverse traverse touching operation, the displayed OSD may disappear if there is no more input within a predetermined time after displaying the OSD.

If it is determined that the direction of the user's touch input follows the predetermined regions 401, 402, 403, 404, 402′, 403′, 404′, 405, 406, 407, 408, and 409, the second controller 300 of the input device 100 for the display apparatus 1 may issue a command for implementing a scroll operation with regard to a menu displayed on one edge corresponding to the user's touch input among the plurality of edges on the screen, and transmit the command to the first communication device 6 of the display apparatus 1.

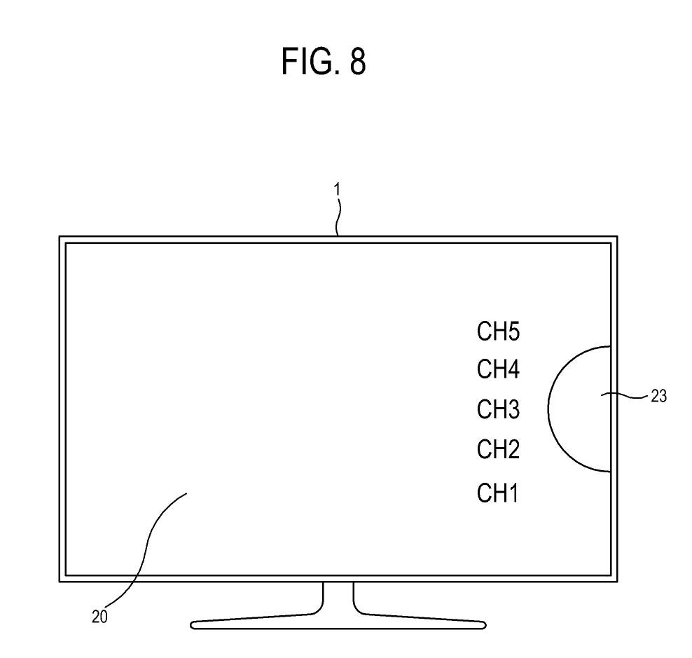

FIG. 8 is a schematic view showing a scroll operation in a menu item displayed sliding from the edge of the screen in accordance with a touch input, on the screen of the display apparatus 1 according to an exemplary embodiment the display apparatus;

As shown in FIG. 8, for example, suppose that a channel selection menu is displayed on a right edge of the screen of the display apparatus 1 in response to a user's touch input traversing the predetermined regions 403. In the state that the channel selection menu is displayed on the right edge of the screen of the display apparatus 1, if the user's touch input is generated following the predetermined region 403, the second controller 300 of the input device 100 may issue a command for implementing a scroll operation with regard to the channel selection menu displayed sliding from the right edge of the screen of the display apparatus 1, and transmit the command to the first communication device 6 of the display apparatus 1.

As described above, according to an exemplary embodiment, the predetermined regions are designated on the touch sensor 400 of the input device 100, so that a user can touch the predetermined region in tangibly traversing and rubbing directions without directly looking the touch sensor 400, thereby transmitting a defined certain signal to the display apparatus 1.

Also, a control direction in the input device 100 is consistent with a position and a displaying direction of a corresponding menu, so that a user can call a certain menu without any separate learning.

A control method for a display system including the foregoing display apparatus and the foregoing input device is described as follows.

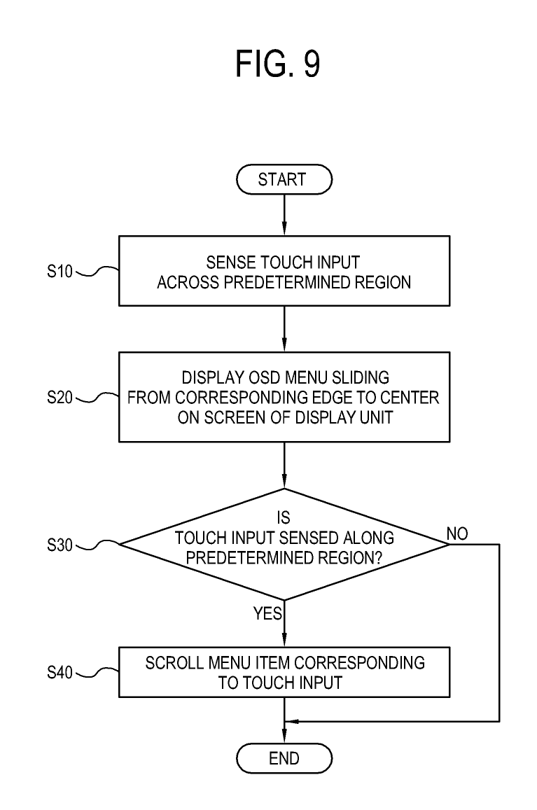

FIG. 9 is a flowchart illustrating a control method of the display system according to an exemplary embodiment.

First, a user touches the predetermined region on the touch sensor of the input device in a transverse direction from the outside to the inside.

If the touch input traversing the predetermined region is sensed (operation S10), the second controller of the input device issues a command for activating a menu corresponding to the user's touch input from one edge of the screen among the plural edges of the screen and transmits the command to the first communication device of the display apparatus, thereby allowing the display apparatus to display a menu sliding in a direction from the corresponding edge of the screen to the center of the screen (operation S20).

Then, the second controller of the input device determines whether a touch input following the predetermined region is further sensed (operation S30).

If the touch input following the predetermined region is additionally sensed (Yes of operation S30), the second controller of the input device issues a command for implementing a scroll operation with regard to the menu displayed corresponding to the user's touch input from one edge among the plural edges of the screen, and transmits the command to the first communication device of the display apparatus, thereby allowing the menu on the display apparatus to be scrolled in response to the touch input (operation S40).

As described above, a predetermined time may be set up between the touch input traversing the predetermined region and the touch input following the predetermined region. Thus, if there are no more inputs within the predetermined time after displaying the menu, the displayed menu may disappear.

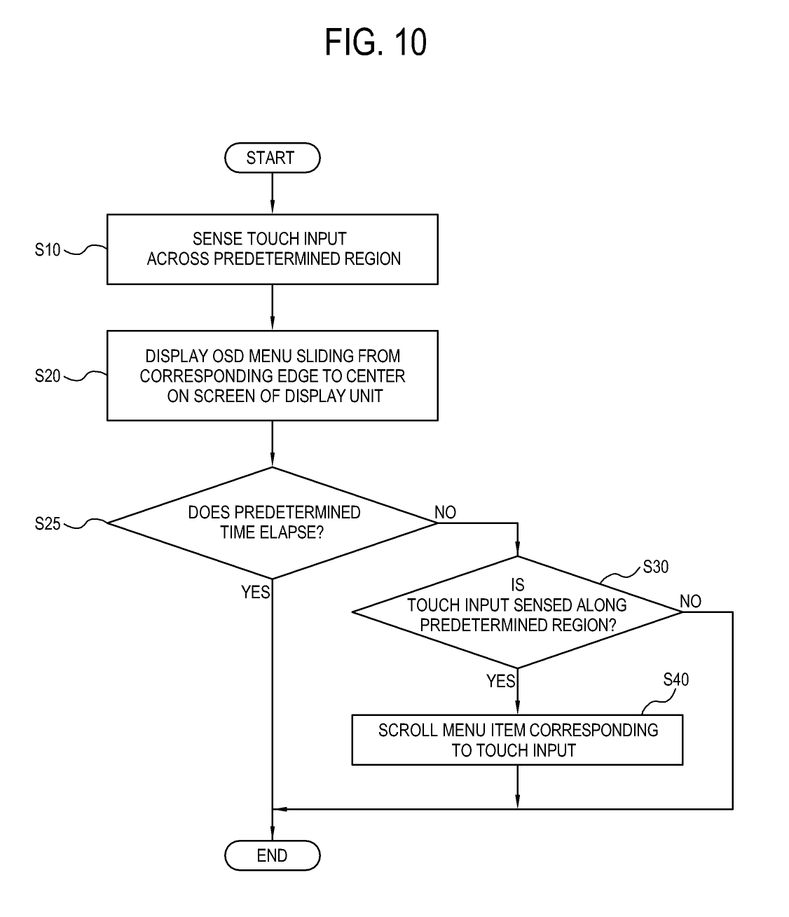

FIG. 10 is a flowchart illustrating a control method of the display system according to another exemplary embodiment.

In this exemplary embodiment, an operation (operation S25) of determining whether a predetermined time is elapsed is added between the operations S20 and S30 of FIG. 9.

First, a user touches the predetermined region on the touch sensor of the input device in a transverse direction from the outside to the inside.

If the touch input traversing the predetermined region is sensed (operation S10), the second controller of the input device issues a command for activating a menu corresponding to the user's touch input from one edge among the plural edges of the screen and transmits the command to the first communication device of the display apparatus, thereby allowing the display apparatus to display a menu sliding in a direction from the corresponding edge of the screen to the center of the screen (operation S20).

Then, it is determined whether a predetermined time has elapsed (operation S25).

If the predetermined time has elapsed (Yes of operation S25), the displayed menu disappears in a sliding manner.

If the predetermined time has not elapsed (No of operation S25), the second controller of the input device further determines whether the touch input following the predetermined region is additionally sensed (operation S30).

If the touch input following the predetermined region is additionally sensed (Yes of operation S30), the second controller of the input device issues a command for implementing a scroll operation with regard to the menu displayed corresponding to the user's touch input from one edge among the plural edges of the screen and transmits the command to the first communication device of the display apparatus, thereby allowing the menu on the display apparatus to be scrolled in response to the touch input (operation S40).

As described above, a predetermined time may be set up between the touch input traversing the predetermined region and the touch input following the predetermined region. Thus, if there are no more inputs within the predetermined time after displaying the menu, the displayed menu may disappear.

As described above, according to an exemplary embodiment, the predetermined regions are allocated on the touch sensor of the input device, so that a user can touch the predetermined region in tangibly traversing and rubbing directions without directly looking the touch sensor, thereby transmitting a defined certain signal to the display apparatus.

A control direction in the input device is consistent with a position and a displaying direction of a corresponding menu, so that a user can call a certain menu without any separate learning.

Although a few exemplary embodiments have been shown and described, it will be appreciated by those skilled in the art that changes may be made in these exemplary embodiments without departing from the principles and spirit of the exemplary embodiments, the scope of which is defined in the appended claims and their equivalents.

What is claimed is:

1. An input device for a display apparatus, the input device comprising:
a communication device configured to communicate with the display apparatus;
a touch sensor which comprises predetermined regions which correspond to a plurality of edges of a screen of the display apparatus, and which is configured to receive a user's touch input; and
a controller configured to determine a direction of the user's touch with respect to at least one of the predetermined regions.

2. The input device according to claim 1, wherein the direction of the touch input comprises a direction traversing the at least one of the predetermined regions and a direction following the at least one of the predetermined regions.

3. The input device according to claim 1, wherein the display apparatus activates a menu from at least one edge among the plurality of edges of the screen corresponding to the determined direction of the touch input while communicating with the communication device.

4. The input device according to claim 1, wherein the at least one of the predetermined regions has a bar shape of a predetermined length.

5. The input device according to claim 1, wherein the at least one of the predetermined regions has a dot shape.

6. The input device according to claim 1, wherein the at least one of the predetermined regions protrudes to a predetermined height.

7. The input device according to claim 1, wherein the predetermined region is grooved to a predetermined depth.

8. A display apparatus comprising:
a signal receiver configured to receive a video signal;
a signal processor configured to process the received video signal;
a display configured to display an image based on the received video signal on a screen;
a communication device configured to communicate with an input device configured to receive a user's touch input; and
a controller configured to control a menu to be activated from at least one edge among plural edges of the screen corresponding to the user's touch input.

9. The display apparatus according to claim 8, wherein the input device comprises a predetermined region which protrudes in relation to the plurality of edges, and
a direction of the user's touch input is determined with respect to the predetermined region.

10. The display apparatus according to claim 8, wherein the direction of the user's touch input comprises a direction traversing the predetermined region and a direction following the predetermined region.

11. The display apparatus according to claim 8, wherein the predetermined region has a bar shape which has a predetermined length.

12. The display apparatus according to claim 8, wherein the predetermined region has a dot shape.

13. The display apparatus according to claim 8, wherein the predetermined region protrudes to a predetermined height.

14. The display apparatus according to claim 8, wherein the predetermined region is grooved to a predetermined depth.

15. A display system comprising a display apparatus and an input device,
the display apparatus comprising:
a signal receiver configured to receive a video signal;
a signal processor configured to process the video signal;
a display configured to display an image on a screen based on the received video signal;
a communication device configured to communicate with an input device configured to receive a user's touch input; and
a controller configured to control a menu to be activated from at least one edge among a plurality of edges of the screen which corresponds to the user's touch input, and
the input device comprising:
a communication device configured to communicate with the display apparatus;
a touch sensor which comprises at least one predetermined region corresponding to the plurality of edges of the screen of the display apparatus, and which is configured to receive the user's touch input; and
a controller configured to determine a direction of the user's touch input with respect to the predetermined regions.

16. The display system according to claim 15, wherein the direction of the user's touch input comprises a direction traversing the predetermined region and a direction following the predetermined region.

17. The display system according to claim 15, wherein the display apparatus activates the menu from one edge among the plural edges of the screen corresponding to the determined direction of the user's touch input while communicating with the communication device.

18. The display system according to claim 15, wherein the predetermined region is has a bar shape which has a predetermined length.

19. The display system according to claim 15, wherein the predetermined region has a dot shape.

20. The display system according to claim 15, wherein the predetermined region protrudes to a predetermined height.

21. The display system according to claim 15, wherein the predetermined region is grooved to have a predetermined depth.

22. A control method of a display system comprising a display apparatus and an input device, the control method comprising:
inputting, by a user, a touch through the input device comprising a predetermined region protruding in relation to a plurality of edges of a screen of the display apparatus;
determining, by the input device, a direction of the user's touch input with respect to the predetermined region;
transmitting, by the input device, the user's touch input, of which the direction is determined, to the display apparatus; and
controlling, by the display apparatus, a menu to be activated from one edge among the plurality of edges of the screen corresponding to the received user's touch input.

23. The control method according to claim 22, wherein, the determining, by the input device, the direction of the user's touch input with respect to the predetermined region comprises determining one of a direction traversing the predetermined region and a direction following the predetermined region.

24. The control method according to claim 23, wherein if it is determined that the user's touch input traverses the predetermined region, the display apparatus controls the menu to be activated from the one edge among the plurality of edges of the screen corresponding to the received user's touch input.

25. The control method according to claim 24, wherein if it is determined that the user's touch input follows the predetermined region, the display apparatus controls a scroll operation to be implanted with regard to an item of the activated menu.

26. A control method of a display system comprising a display apparatus and an input device, the control method comprising:
receiving a user's touch input at a predetermined region of a touch sensor of the input device;
transmitting the user's touch input to a controller of the display apparatus;
activating, by the controller of the display apparatus, a menu corresponding to at least one edge of a plurality of edges of a screen of the display apparatus in response to the user's touch input.

27. The method of claim 26, wherein a number of predetermined regions corresponds to a number of edges of the display apparatus.

28. The method of claim 27, wherein at least one of the predetermined regions protrudes to a predetermined height above a plane of a surface of the touch sensor.

29. The method of claim 27, wherein the predetermined region is grooved to a predetermined depth below a plane of a surface of the touch sensor.
